(19) United States
(12) Patent Application Publication
(10) Pub. No.: US 2024/0163534 A1
(43) Pub. Date: May 16, 2024

(54) Audio Video Interface And Related System For Broadcast Handholes

(71) Applicant: David Cody Oliva, Braintree, MA (US)

(72) Inventor: David Cody Oliva, Braintree, MA (US)

(21) Appl. No.: 18/054,580

(22) Filed: Nov. 11, 2022

(51) Int. Cl. H04N 5/225; H04N 7/18

(52) U.S. Cl. CPC H04N 5/2251; H04N 7/18

(57) ABSTRACT

An audio video interface is disclosed herein. The audio video interface may advantageously be connected to audio and video cables used to broadcast sports games played on fields. The interface may generally comprise all components necessary to achieve this intended use, including, but not limited to, an enclosure connected to a frame by brackets, wherein the frame is configured to be attached to the walls of a box where the broadcasting audio and video cables are held. The enclosure may comprise electrical receptacles that are identical to the electrical connectors on the ends of the broadcasting audio and video cables, which may facilitate the interface's intended use.

### BACKGROUND

### Technical Field

The present disclosure relates generally to an audio video (“AV”) interface and related systems for broadcast handholes. More particularly the present disclosure relates to an AV interface comprising a variety of connectors and receptacles connected to an enclosure that may be attached to the walls of a handhole via a frame having extension arms.

### Description of Related Art

It is desirable to have appropriate equipment to broadcast sports games played on fields, such as football, baseball, soccer, and the like. This equipment may include microphones, headsets, cameras, and the like, which are both known in the art and necessary to begin the transmission of audio and video information to the internet or television. The broadcasting equipment is typically connected to a press box that is capable of transmitting audio and video signals over the airwaves. As will be appreciated by those skilled in the art, the cables necessary to connect this equipment to the press box are extensive and require a convenient storage location on the field.

The convenient storage location typically used for these broadcasting cables, referred to as “homerun cables,” is a closed or opened-bottom aluminum box recessed into the field surface. The aluminum boxes recessed in the field are referred to as “handholes,” and the homerun cables may be coiled and stored inside the handholes, which may be covered by a lid when the cables are not in use. The homerun cables may then extend underground and ultimately terminate at an appropriate receptacle or connection in a press box. When the homerun cables are needed on the field, they are unraveled and connected to the appropriate broadcasting equipment, preferably by appropriate technical personnel.

There are numerous potential problems with this arrangement. For example, homerun cables that are coiled up may be unraveled incorrectly, which may cause tangling or crimping and thus permanently damage the cables. Additionally, water from excess rain or field flooding may seep through the lid of the handhole and potentially permanently damage the cables, which may result in the cables being inoperable and needing to be replaced. Any damage to the homerun cables that render them unreliable or inoperable is costly to repair.

There are other problems and several potential solutions to these problems; however, the results from applying any one of these potential solutions would be unpredictable. Therefore, what is needed is an AV interface having the following characteristics and benefits over the prior art.

### SUMMARY

The subject matter of this application may involve, in some cases, interrelated products, alternative solutions to a particular problem, and/or a plurality of different uses of a single system or article.

In one aspect an audio video interface is disclosed. In this aspect, the audio video interface comprises an enclosure, a frame, and extension arms. The enclosure is attached to the frame by a bracket, and the extension arms are attached to the frame by fasteners. Also, in this aspect, the enclosure includes a number of electrical receptacles on its front or top face.

In another aspect, a system that includes the audio video interface is disclosed. In this aspect, the audio video interface of the system includes all components disclosed in the previous aspect. The system includes a handhole, particularly the interior side walls of a handhole, and the interface is attached to the interior side walls of the handhole by the extension arms of the interface. The extension arms are held to the interior side walls of the handhole by screws.

It should be expressly understood that the various physical elements of the present disclosure summarized and further disclosed herein may be of varying sizes, shapes, or otherwise dimensions and made from a variety of different materials or methods of manufacture without straying from the scope of the present disclosure.

### BRIEF DESCRIPTION OF THE DRAWINGS

FIG. 1 provides a top side perspective view of an embodiment of the present disclosure.

FIG. 2 provides an angled perspective view of another embodiment of the present disclosure.

FIG. 3 provides a semi-cross sectional perspective view of yet another embodiment of the present disclosure.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns an AV interface and related systems for broadcast handholes. The AV interface is an assembly, or a system constructed from a combination of various parts. For example, in one embodiment, the AV interface may comprise an enclosure attached to a frame by brackets, wherein the frame is configured to be attached to the interior walls of a handhole. The enclosure may be configured to attach to homerun cables already in the handhole by having cables with mated connectors extending from a rear or bottom side of the enclosure. A top face of the enclosure may comprise a plurality of receptacles that are configured to connect to broadcasting equipment cables, also referred to as “patch cables.” In one embodiment, the frame connected to the enclosure may be attached to the interior walls of the handhole by extension arms.

While the AV interface is designed to be used with either newly installed homerun cables in new handholes or to be retrofitted into existing handholes and permanently connected to existing homerun cables already in place, it is apparent that the AV interface could serve other purposes not explicitly mentioned herein. It should be expressly understood that these other uses for the AV interface are within the scope of the present disclosure. It should also be understood that the AV interface and its components may be manufactured from any suitable material. However, in a preferred embodiment, the enclosure may be made from a polycarbonate, gasketed material, and the frame and connecting brackets on the frame may be made from made from a metal material. Similarly, the extension arms may be manufactured from a metal material as well. For example, in one embodiment, the metal material may be aluminum.

In one embodiment, the extension arms may be attached to the frame by fasteners and secured to the interior walls by screws. The screws connecting the extension arms to the walls of the handhole may be self-tapping or self-drilling screws, thus removing the need to pre-drill a hole in the walls of the handhole. In most embodiments, the cables extending from the rear or bottom side of the enclosure that are configured to attach to the homerun cables in the handhole may be relatively short in length, which is critical to the present disclosure. Specifically, it is critical that the cables extending from the rear or bottom of the enclosure be shorter than the audio and video cables already in the handhole. This may help with organization and also importantly decreases the risk of cable crimping.

Another critical aspect of the present disclosure is that the AV interface and its components must be at least water resistant, if not entirely waterproof. The reason for this is that known methods of preventing water damage to homerun cables are either suboptimal or completely ineffective. For example, water from excess rain or flooding on the field may seep into the handhole through the lid and permanently damage the homerun cables inside. Accordingly, in order to mitigate or completely avoid this problem, in one embodiment, the receptacles and connectors on the top face of the interface may be equipped with watertight caps to prevent water damage when the receptacles or connectors are not in use. Similarly, the cables that extend from the rear of the interface and connect to the homerun cables may be covered by watertight cord grips. Moreover, while the scope of the present disclosure is not limited to the use of a particular material, it is critical that the caps be made from a waterproof or water resistant material, such as, for example, rubber or silicone.

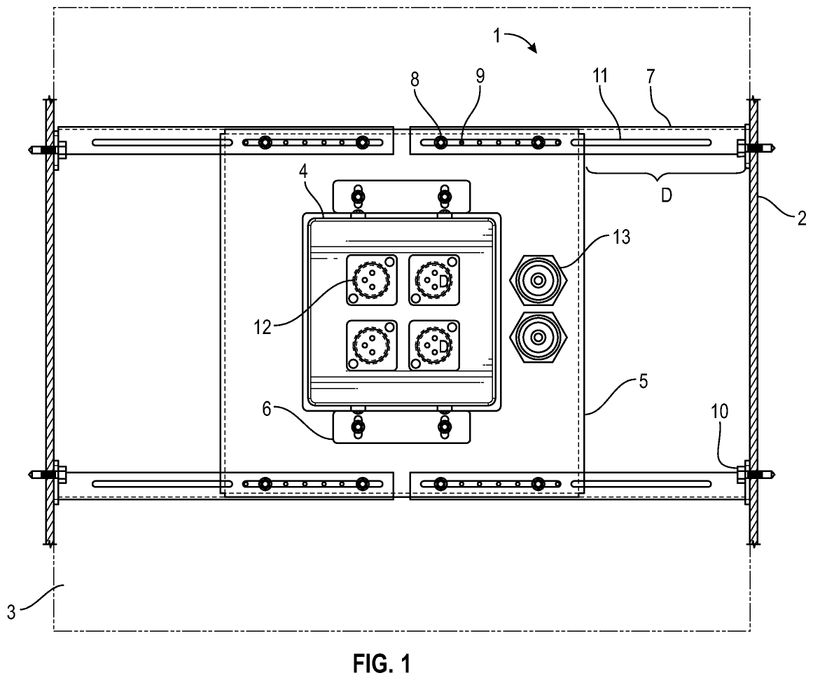

Turning now to FIG. 1, which provides a top-side perspective view of an embodiment of the AV interface 1 attached to the side walls 2 of a handhole 3. In this embodiment, the AV interface 1 comprises an enclosure 4 connected to a frame 5 by brackets 6. The frame 5 is connected to the walls 2 of the handhole 3 by extension arms 7, which are connected to the frame 5 by externally threaded fasteners 8 twisted through fastener-sized openings 9 defined in the sides of frame 5. In this embodiment, externally threaded fasteners 8 also connect the brackets 6 to the enclosure 4 and the frame 5. Screws 10 connect the extension arms 7 to the walls 2 of the handhole 3.

The distance D between the sides of the frame 5 and the walls 2 of the handhole 3 may be adjusted by fastening the extension arms 7 to different openings 9, twisting the extension arm fasteners 8 through different elongated openings 11 defined in the extension arms 7, or both. For example, depending on the size of the handhole 3 or the location of the homerun cables within the handhole 3, the location of the enclosure 4 may need to be adjusted by adjusting the position of the frame 5. In this embodiment, the numerous fastener-sized openings 9 on the sides of the frame 5 and the elongated openings 11 in the extension arms 7 allow the distance D to be adjusted in a variety of ways. The process of removing the fasteners 8 and twisting them through different openings 9, 11 may be referred to as adjusting the length of the extension arms 7. Once the extension arms 7 are adjusted to the desired length, the various electrical receptacles 12 and electrical connectors 13 on the AV interface 1 may then be utilized by end users.

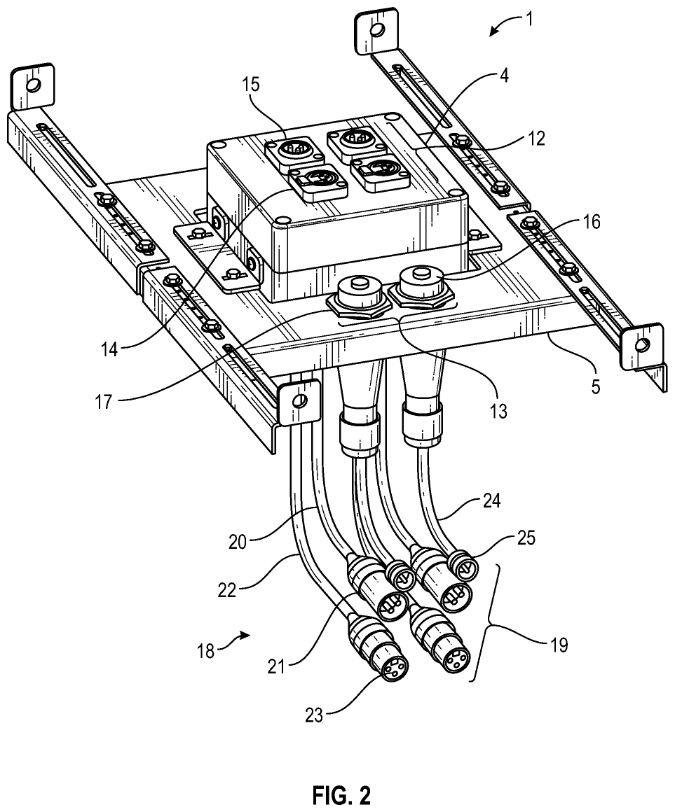

Turning now to FIG. 2, which provides an angled perspective view of another embodiment of the AV interface 1, the enclosure 4 comprises four electrical receptacles 12 on its front face, and the frame 5 comprises two electrical connectors 13 also on its front face. In this preferred embodiment, the four electrical receptacles 12 include two female external line return (“XLR”) receptacles 14 and two male XLR receptacles 15. The frame 5 includes two coaxial cable connectors 16, which may also be referred to as “BNC connectors” 16. In this embodiment, the BNC connectors 16 are seated on the frame 5 and extend through apertures 17 defined in the frame 5.

Each of the receptacles 12 and connectors 13 are electrically connected to short, terminated cables, referred to as “whips” 18. The whips 18 extend from the bottom or rear of the interface 1 and terminate in mated connectors 19 that are the opposite of the receptacle 12 or connector 13 that the whips 18 are attached to. For example, in the preferred embodiment shown, the two female XLR receptacles 14 are electrically connected to whips 20 that terminate in male XLR connectors 21. The two male XLR receptacles 15 are electrically connected to whips 22 that terminate in female XLR connectors 23, and the female BNC connectors 16 are electrically connected to whips 24 that terminate in male compression connectors 25, which may be referred to as male “F connectors” 25.

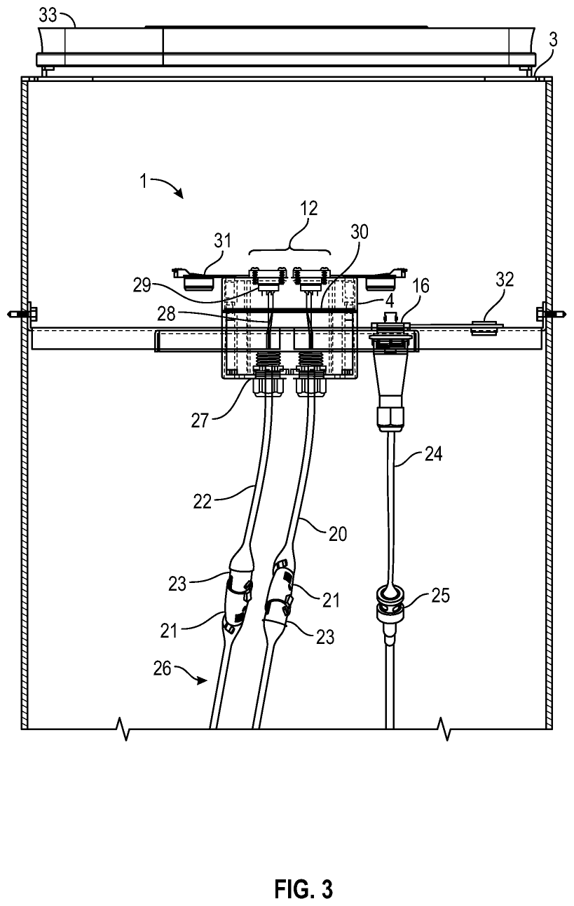

As shown in the cross-sectional view of FIG. 3, by terminating in mated connectors 19 that are the opposite of the connected receptacle 12 or connector 13, the interface 1 is effectively configured to connect to newly installed or existing homerun cables 26 in the handhole 3. For example, the whips 20, 22 that terminate in male and female XLR connectors 21, 23 connect to female and male XLR 23, 21 connectors, respectively, in the handhole 3. In this embodiment, the connections between the whips 20, 22, and the homerun cables 26 are either water resistant or watertight once the connection is made due to the whips 20, 22 being covered in watertight cord grips. Similarly, the coaxial cable whips 24 that terminate in male F connectors 25 are connected to corresponding female F connectors in the handhole. In one embodiment, the permanent connection between the F connectors 25 is covered by a rubber shrink tube in order to prevent water damage to the connection.

The audio cable whips 20, 22 are connected to electrical receptacles 12 through apertures 27 on the bottom or rear side of the enclosure 4, wherein the wires 28 within the whips 20, 22 are connected directly to solder cups 29 integral with the receptacles 12 by a soldered connection, for example. When not in use, the receptacles 12 may be covered by caps 31, which in this embodiment are integral rubber caps, and the BNC connecters 16 may be covered by screw-on caps 32. The caps 31, 32 may form water resistant or watertight connections with the respective receptacles 12 or connectors 13 to prevent a malfunction from the ingress of water through the handhole lid 33. Similarly, in this embodiment, the enclosure 4 protects the electrical connections within the enclosure 4 from water damage by utilizing at least one gasket seal 30 between the top and bottom of the enclosure 4. In this way, every aspect of the disclosed interface 1 provides a water-resistant solution.

While several variations of the present disclosure have been illustrated by way of example in preferred or particular embodiments, it is apparent that further embodiments could be developed within the spirit and scope of the present disclosure, or the inventive concept thereof. However, it is to be expressly understood that elements described in one embodiment may be incorporated with any other embodiment in combination with any other elements disclosed herein in the various embodiments. It is also to be expressly understood that any modifications and adaptations to the present disclosure are within the spirit and scope of the present disclosure, and are inclusive, but not limited to the following appended claims as set forth.

What is claimed is:

1. An audio video interface comprising:
an enclosure, a frame, and a plurality of extension arms;
wherein the enclosure is attached to the frame by a bracket, and the plurality of extension arms are attached to the frame by a first plurality of fasteners; and
wherein the enclosure comprises a plurality of electrical receptacles on a front face of the enclosure.

2. The audio video interface of claim 1 further comprising a plurality of whips extending from a rear face of the enclosure.

3. The audio video interface of claim 2 wherein the plurality of whips comprise a plurality of watertight cord grips.

4. The audio video interface of claim 1 further comprising a plurality of caps attached to the plurality of electrical receptacles.

5. The audio video interface of claim 1 wherein the bracket is attached to the frame and the enclosure by a second plurality of fasteners.

6. The audio video interface of claim 1 wherein the frame defines a plurality of openings configured to receive at least one of the first plurality of fasteners.

7. The audio video interface of claim 1 wherein each one of the plurality of extension arms defines an elongated opening configured to receive at least one of the first plurality of fasteners.

8. The audio video interface of claim 1 further comprising a plurality of electrical connectors seated on the frame and extending through a plurality of apertures defined in the frame.

9. The audio video interface of claim 8 further comprising a plurality of caps attached to the plurality of electrical connectors.

10. The audio video interface of claim 8 wherein the plurality of electrical connectors comprise two female BNC connectors.

11. The audio video interface of claim 8 wherein the plurality of electrical connectors extend through the plurality of apertures and terminate at and comprise a plurality of male F connectors.

12. The audio video interface of claim 1 wherein two of the plurality of electrical receptacles comprise male XLR receptacles.

13. The audio video interface of claim 1 wherein two of the plurality of electrical receptacles comprise female XLR receptacles.

14. The audio video interface of claim 1 further comprising two whips extending from a rear face of the enclosure, the two whips terminating at and comprising two female XLR connectors.

15. The audio video interface of claim 1 further comprising two whips extending from a rear face of the enclosure, the two whips terminating at and comprising two male XLR connectors.

16. A system comprising an audio video interface and a handhole, the handhole comprising a plurality of interior side walls, and the audio video interface comprising:
an enclosure, a frame, and a plurality of extension arms;
wherein the enclosure is attached to the frame by a bracket, and the plurality of extension arms are attached to the frame by a first plurality of fasteners;
wherein the enclosure comprises a plurality of electrical receptacles on a front face of the enclosure;
wherein the plurality of extension arms are attached to the plurality of interior side walls by a plurality of screws.

17. The system of claim 16 wherein the audio video interface further comprises a plurality of whips extending from a rear face of the enclosure.

18. The system of claim 17 wherein the plurality of whips extending from the rear face of the enclosure terminate at and comprise a plurality of mated connectors.

19. The system of claim 18 wherein the plurality of mated connectors are attached to a plurality of homerun cables in the handhole.

20. The system of claim 19 wherein a plurality of connections between the plurality of mated connectors and the plurality of homerun cables are water resistant.
